(19) United States
(12) Patent Application Publication
(10) Pub. No.: US 2025/0140464 A1
(43) Pub. Date: May 1, 2025

(54) I-SHAPED INDUCTOR AND TRANSFORMER

(71) Applicants: Jiaxiong HE, Taoyuan City (CN); Zhengzhe CHEN, Taoyuan City (CN); JIANGXI GUDIAN ELECTRONICS CO., LTD., Ji'an City (CN)

(72) Inventor: Jiaxiong HE, Taoyuan City (CN)

(21) Appl. No.: 18/808,931

(22) Filed: Aug. 19, 2024

(30) Foreign Application Priority Data
Oct. 25, 2023 (CN) 202311384964.6

(51) Int. Cl. H01F 17/04; H01F 19/00; H01F 27/30

(52) U.S. Cl. CPC H01F 17/04; H01F 19/00; H01F 27/306

(57) ABSTRACT

An I-shaped inductor and a transformer are provided. The I-shaped inductor includes an I-shaped iron core and two coils. The I-shaped iron core includes one winding part and two connecting parts, the two connecting parts are respectively positioned on both ends of the winding part, one side of the connecting part is a connecting side, both ends of the connecting side are respectively provided with two electroplating pins, the two coils are wound on the winding part, each connecting part is connected with both ends of a corresponding coil, and ends of different coils are respectively connected to the electroplating pins on different connecting parts. The transformer includes a cover plate and at least two I-shaped inductors.

### CROSS-REFERENCE TO RELATED APPLICATION

This patent application claims the benefit and priority of Chinese Patent Application No. 202311384964.6 filed with the China National Intellectual Property Administration on Oct. 25, 2023, the disclosure of which is incorporated by reference herein in its entirety as part of the present application.

### TECHNICAL FIELD

The present disclosure relates to the technical field of transformers, in particular to an I-shaped inductor and a transformer.

### BACKGROUND

The existing transformer has inductance less than the ideal value, insufficient flux density and insufficient high voltage spacing. Moreover, various types of traditional transformers require respectively specific iron core components, resulting that the production cost is relatively high.

### SUMMARY

The present disclosure aims to provide an I-shaped inductor and a transformer to solve the problems in the prior art, so that the production capacity can be increased, the production cost can be reduced and the inductance can also be improved.

In order to achieve the purpose, the present disclosure provides the following scheme.

The present disclosure provides an I-shaped inductor. The I-shaped inductor includes an I-shaped iron core and two coils. The I-shaped iron core includes one winding part and two connecting parts. are respectively positioned on both ends of the winding part, one side of each of the two connecting parts is a connecting side, both ends of the connecting side are respectively provided with two electroplating pins, the two coils are wound on the winding part, each of the two connecting parts is connected with both ends of a corresponding one of the two coils, and ends of different coils are respectively connected to the electroplating pins on different connecting parts.

Preferably, the I-shaped iron core is made of nickel-zinc material.

Preferably, ends of the two coils are fixed to the two connecting parts by welding.

Preferably, the electroplated pins comprise a first pin, a second pin, a third pin and a fourth pin, the first pin and the second pin are located on one of the two connecting parts, the third pin and the fourth pin are located on an other one of the two connecting parts, both ends of one of the two coils are respectively connected to the first pin and the second pin, and both ends of an other one of the two coils are respectively connected to the third pin and the fourth pin.

The present disclosure also provides a transformer. The transformer includes a cover plate and at least two I-shaped inductors. All electroplated pins have a same orientation, and the cover plate is installed on one side, opposite to the connecting side, of each of the at least two I-shaped inductors.

Preferably, the at least two I-shaped inductors are arranged in sequence in a length direction of the winding part.

Preferably, the at least two I-shaped inductors are arranged in a width direction of the winding part.

Preferably, the cover plate and the at least two I-shaped inductors are adhesively fixed through a magnetic conductive adhesive.

Preferably, the at least two I-shaped inductors form a combined inductor, and one side, away from the electroplated pins, of the combined inductor is overlapped with the cover plate.

The I-shaped inductor provided by the present disclosure includes an I-shaped iron core and two coils. The I-shaped iron core includes one winding part and two connecting parts. The two connecting parts are respectively positioned on both ends of the winding part. One side of each of the two connecting parts is a connecting side. Both ends of the connecting side are respectively provided with two electroplating pins. The two coils are wound on the winding part. Each of the two connecting parts is connected with both ends of a corresponding one of the two coils, and ends of different coils are respectively connected to the electroplating pins on different connecting parts, so that both ends of the coil are located on the same side. Therefore, a plurality of I-shaped inductors can be combined in different forms so as to form different transformers. Further, the inductance of the formed transformer is increased, and the efficiency of automation equipment is improved. Moreover, the whole transformer can be manufactured by means of existing equipment, without special manufacturing equipment, so that the production cost is reduced, and the utilization rate of equipment is increased.

### BRIEF DESCRIPTION OF THE DRAWINGS

To more clearly illustrate the present embodiment of the present disclosure or the technical scheme in the prior art, the following briefly introduces the accompanying drawings to be used in the present embodiment. Apparently, the accompanying drawings in the following description show merely some embodiments of the present disclosure, and those skilled in the art may still derive other drawings from these accompanying drawings without creative efforts.

FIG. 1 is a structural schematic diagram of an I-shaped inductor in Embodiment I.

FIG. 2 is a front view of the I-shaped inductor in FIG. 1.

FIG. 3 is a structural schematic diagram of the I-shaped inductor in FIG. 1 omitting coils.

FIG. 4 is a structural schematic diagram of a transformer in Embodiment II, wherein two I-shaped inductors are arranged side by side.

FIG. 5 is a top view of the transformer in FIG. 4.

FIG. 6 is a side view of the transformer in FIG. 4.

FIG. 7 is a structural schematic diagram of the transformer in FIG. 4 omitting a cover plate.

FIG. 8 is a front view of the transformer in FIG. 7.

FIG. 9 is a principle diagram of a circuit of the transformer in FIG. 4.

FIG. 10 is a structural schematic diagram of a transformer in Embodiment II, wherein two I-shaped inductors are arranged in parallel.

FIG. 11 is a structural schematic diagram of the transformer in FIG. 10 omitting a cover plate.

Reference numerals: 1 winding part; 2 connecting part; 3 electroplated pin; 301 first pin; 302 second pin; 303 third pin; 304 fourth pin; 305 fifth pin; 306 sixth pin; 307 seventh pin; 4 coil; and 5 cover plate.

### DETAILED DESCRIPTION OF THE EMBODIMENTS

The following clearly and completely describes the technical scheme in the embodiments of the present disclosure with reference to the embodiments of the present disclosure. Apparently, the described embodiments are merely a part rather than all of the embodiments of the present disclosure. Based on the embodiment in the present disclosure, all other embodiments acquired by the ordinary technical staff in the art without creative effects fall into the scope of the present disclosure.

The present disclosure aims to provide an I-shaped inductor and a transformer to solve the technical problem that the existing transformer has inductance less than the ideal value, insufficient flux density and insufficient high voltage spacing and high production cost.

To make the foregoing objectives, features and advantages of the present disclosure clearer and more comprehensible, the present disclosure is further described in detail below with reference to the accompanying drawings and specific embodiments.

### Embodiment I

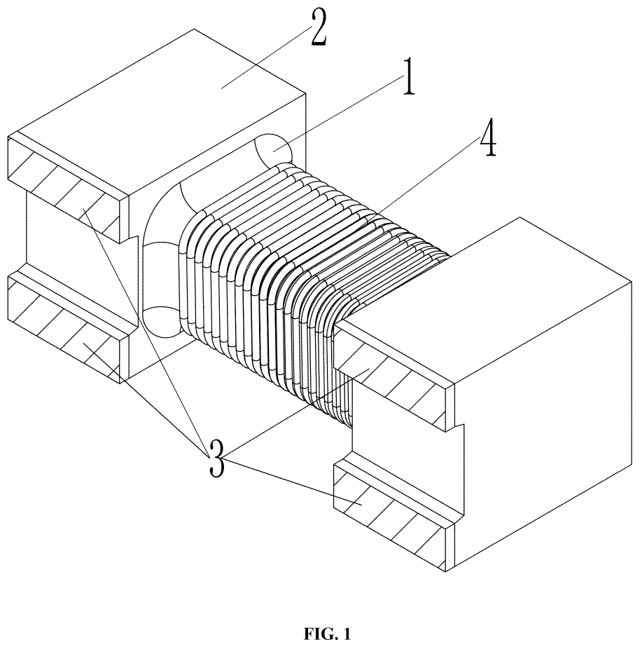

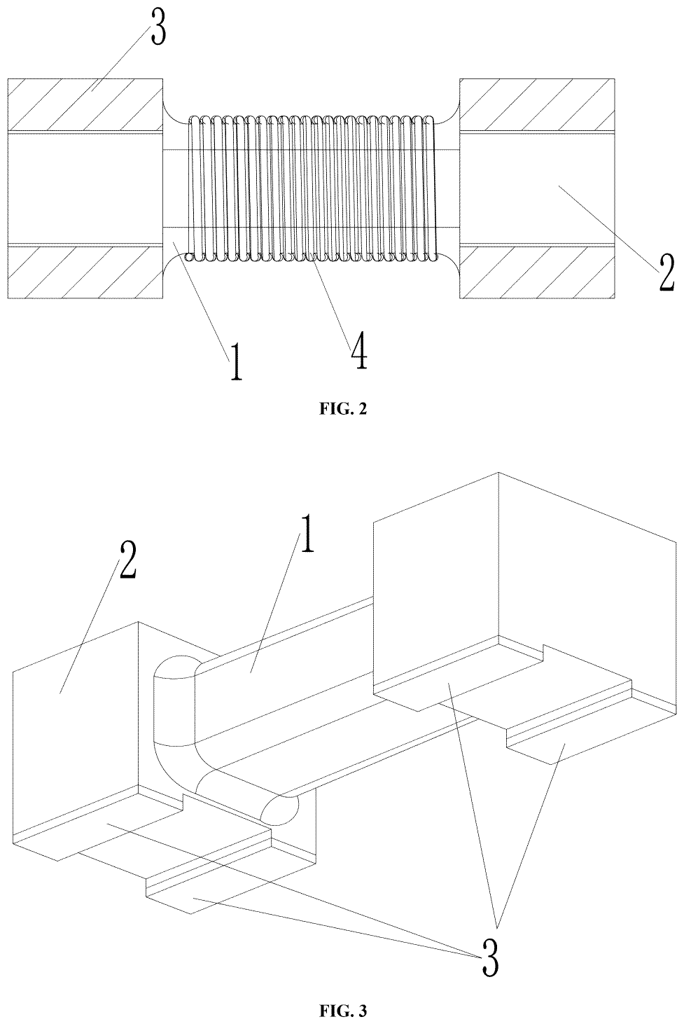

As shown in FIG. 1 to FIG. 3, the embodiment provides an I-shaped inductor. The I-shaped inductor includes an I-shaped iron core and two coils 4. The I-shaped iron core includes one winding part 1 and two connecting parts 2. The two connecting parts 2 are respectively positioned on both ends of the winding part 1. One side of each of the two connecting parts 2 is a connecting side. Both ends of the connecting side are respectively provided with two electroplating pins 3. The two coils 4 are wound on the winding part 1. Each of the two connecting parts 2 is connected with both ends of a corresponding one of the two coils 4, and ends of different coils 4 are respectively connected to the electroplating pins 3 on different connecting parts 2, so that both ends of the coil 4 are located on the same side. Therefore, a plurality of I-shaped inductors can be combined in different forms so as to form different transformers. Further, the inductance of the formed transformer is increased, and the efficiency of automation equipment is improved. Moreover, the whole transformer can be manufactured by means of existing equipment, without special manufacturing equipment, so that the production cost is reduced, and the utilization rate of equipment is increased.

Specifically, the I-shaped iron core is made of nickel-zinc material, has high magnetic conductivity (namely, UI value), and can generate high inductance, high frequency and high transmission.

The coil 4 is made of copper, and both ends of the coil 4 is fixed to the connecting part 2 by welding, improving the connection stability.

The electroplated pins 3 include a first pin 301, a second pin 302, a third pin 303 and a fourth pin 304. The first pin 301 and the second pin 302 are located on one of the two connecting parts 2. The third pin 303 and the fourth pin 304 are located on the other one of the two connecting parts 2. The two coils 4 are wound on the winding part 1 between the two connecting parts 2. Both ends of one of the two coils 4 are respectively connected to the first pin 301 and the second pin 302 via an end of the one of the two connecting parts 2, and both ends of the other one of the two coils 4 are respectively connected to the third pin 303 and the fourth pin 304 via an end of the other one of the two connecting parts 2. Through the above design, the coils 4 can be prevented from being connected in verse.

### Embodiment II

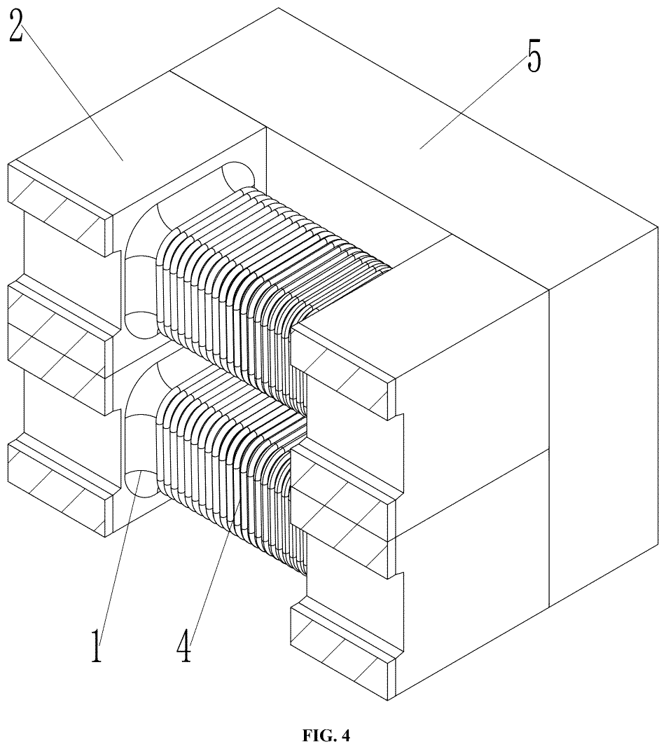

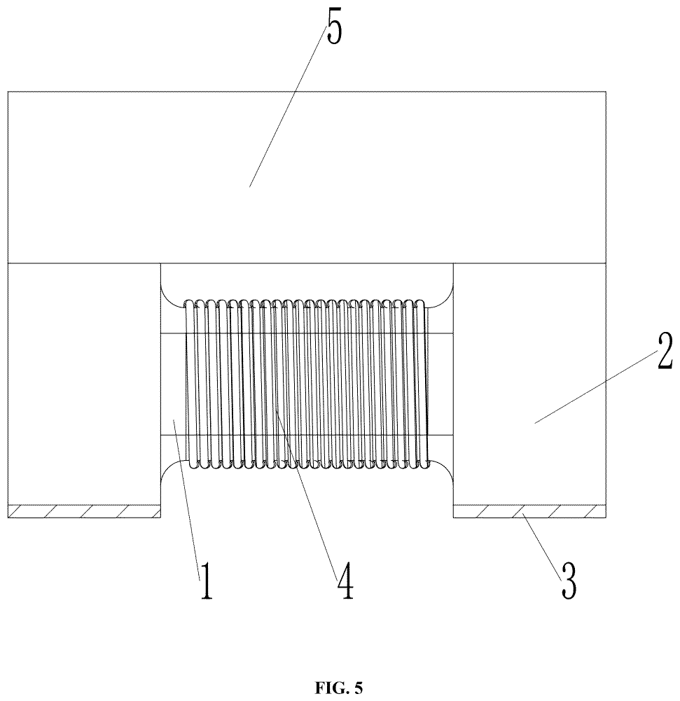

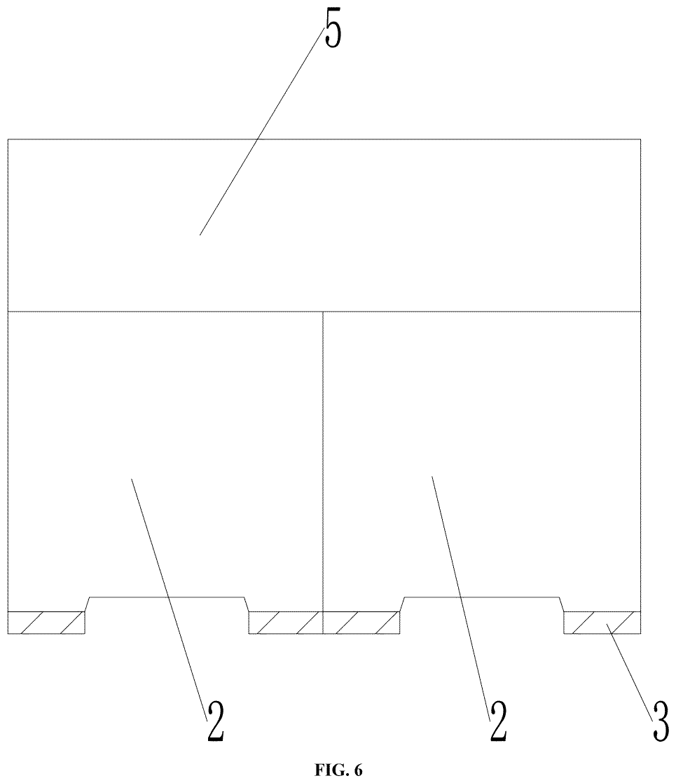

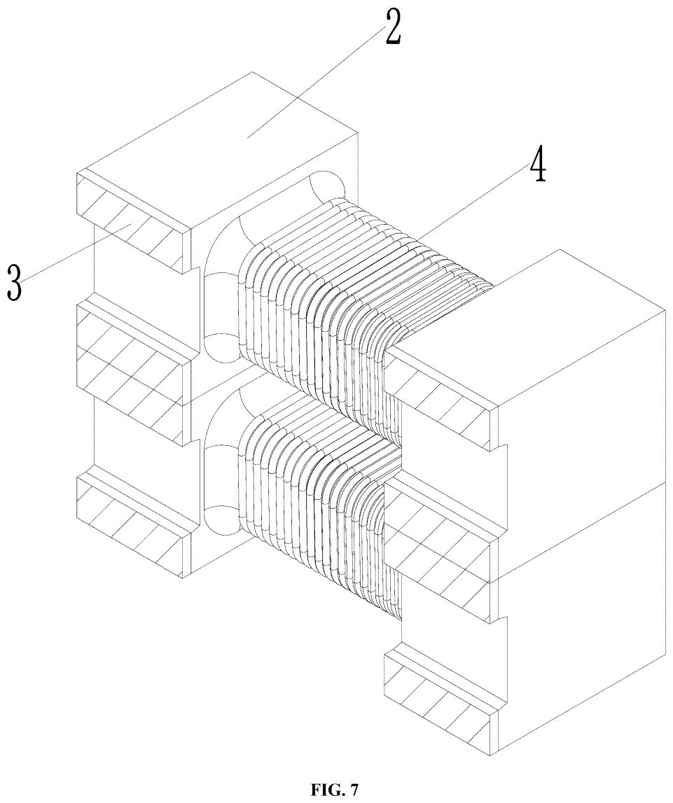

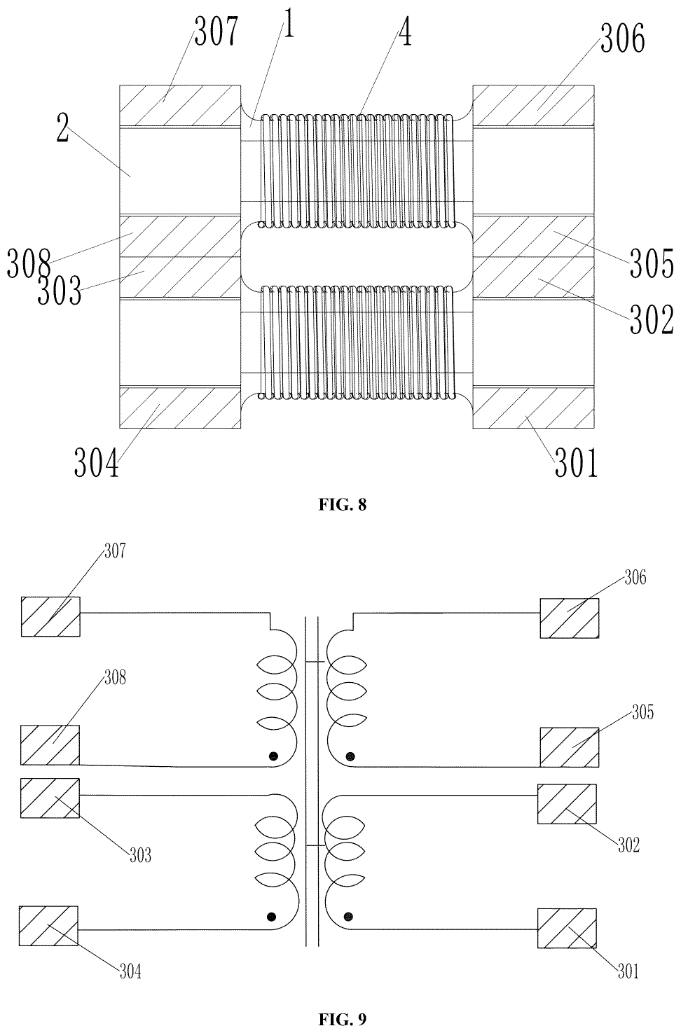

As shown in FIG. 4 to FIG. 11, the embodiment provides a transformer. The transformer includes a cover plate 5 and at least two I-shaped inductors according to Embodiment I. The all electroplated pins 3 have a same orientation to facilitate the connection of the ends of the coils 4, and the cover plate 5 is installed on one side, opposite to the connecting side, of the I-shaped inductor. The cover plate 5 can play roles in insulation and inductance increase. Moreover, by means of the combination of the cover plate 5 and the I-shaped inductors in different forms, various transformers can be formed while the inductance, the magnetic flux density and the high-voltage spacing of the transformers are increased. Moreover, no matter how to arrange the I-shaped inductors, accurate wiring can be realized, and the coils 4 are prevented from being connected in verse.

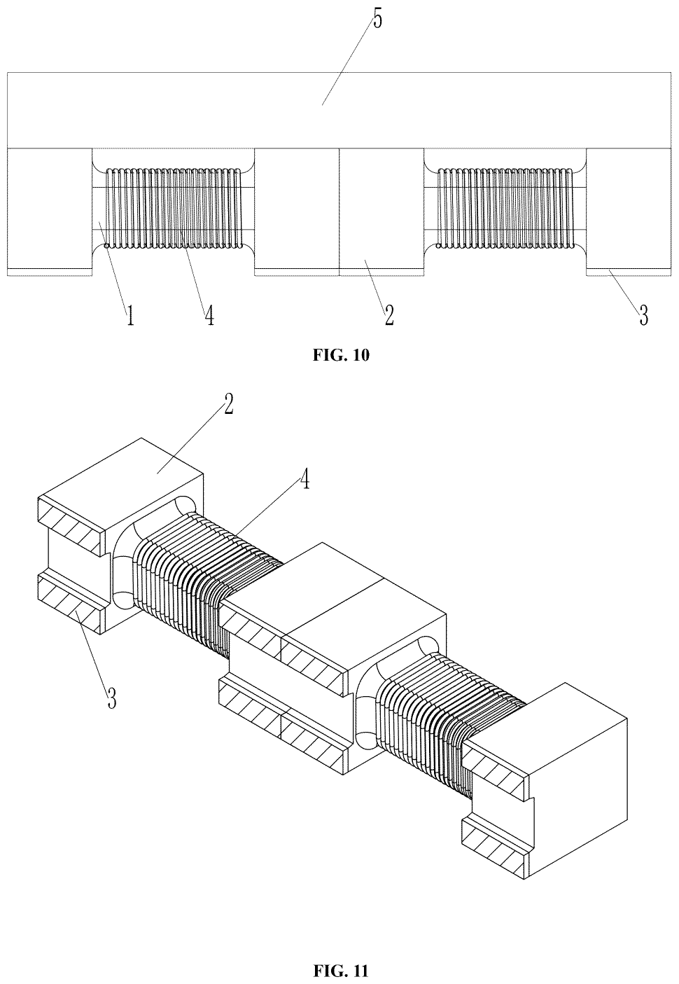

Specifically, as shown in FIG. 10 to FIG. 11, the I-shaped inductors are arranged in sequence in the length direction of the winding part 1.

As another arrangement, as shown in FIG. 4 to FIG. 9, the I-shaped inductors are arranged in the width direction of the winding part 1.

The cover plate 5 and the I-shaped inductor are adhesively fixed by a magnetic conductive adhesive, so that the connecting stability is ensured, and the inductance can also be increased.

A plurality of I-shaped inductors form a combined inductor, and one side, away from the electroplated pins 3, of the combined inductor is overlapped with the cover plate 5.

When a plurality of I-shaped inductors are combined, higher inductance can be formed.

In this embodiment, the specific manufacturing process for winding the coils 4 is as follows, as shown in FIG. 9:
1. A coil is wound in a single loop winding method to being spot welded to the first pin 301, and then is wound 16 TS to connect to the second pin 302 and another coil is wound in a single loop winding method to being spot welded to the fourth pin 304, and then is wound 16 TS to connect to the third pin 303; and
2. A coil is wound in a single loop winding method to being spot welded to the eighth pin 308, and then is wound 16 TS to connect to the seventh pin 307 and another coil is wound in a single loop winding method to being spot welded to the fifth pin 305, and then is wound 16 TS to connect to the sixth pin 306.

However, in this embodiment, the number of winding turns (namely, TS) can be adaptively changed by those skilled in the art according to actual needs so as to manufacture products with different specifications.

As a specific application embodiment, the specific form of the transformer in this embodiment may be formed by the transformation of the coils 4 in the following cases:
a. When the two coils 4 on the same I-shaped inductor are serially connected together. Namely, when the two coils 4 are connected, a common pulse transformer is formed.
b. When the two coils 4 on the same I-shaped inductor are not directly connected, an isolation transformer or a filter is formed.
c. When the numbers of windings of two coils 4 on the same I-type inductor are different, a signal transformer can be formed. Namely, the signal can be amplified or reduced by changing the proportion of the number of windings of coils 4.

Specific examples are used for illustration of the principles and implementation methods of the present disclosure. The description of the above-mentioned embodiments is used to help illustrate the method and the core principles of the present disclosure; and meanwhile, those skilled in the art can make various modifications in terms of specific embodiments and scope of application in accordance with the teachings of the present disclosure. In conclusion, the content of this specification shall not be construed as a limitation to the present disclosure.

What is claimed is:

1. An I-shaped inductor comprising an I-shaped iron core and two coils, wherein the I-shaped iron core includes one winding part and two connecting parts, the two connecting parts are respectively positioned on both ends of the winding part, one side of each of the two connecting parts is a connecting side, both ends of the connecting side are respectively provided with two electroplating pins, the two coils are wound on the winding part, each of the two connecting parts is connected with both ends of a corresponding one of the two coils, and ends of different coils are respectively connected to the electroplating pins on different connecting parts.

2. The I-shaped inductor according to claim 1, wherein the I-shaped iron core is made of nickel-zinc material.

3. The I-shaped inductor according to claim 1, wherein ends of the two coils are fixed to the two connecting parts by welding.

4. The I-shaped inductor according to claim 1, wherein the electroplated pins comprise a first pin, a second pin, a third pin and a fourth pin, the first pin and the second pin are located on one of the two connecting parts, the third pin and the fourth pin are located on an other one of the two connecting parts, both ends of one of the two coils are respectively connected to the first pin and the second pin, and both ends of an other one of the two coils are respectively connected to the third pin and the fourth pin.

5. A transformer comprising a cover plate and at least two I-shaped inductors according to claim 1, all electroplated pins have a same orientation, and the cover plate is installed on one side, opposite to the connecting side, of each of the at least two I-shaped inductors.

6. The transformer according to claim 5, wherein the at least two I-shaped inductors are arranged in sequence in a length direction of the winding part.

7. The transformer according to claim 5, wherein the at least two I-shaped inductors are arranged in a width direction of the winding part.

8. The transformer according to claim 5, wherein the cover plate and the at least two I-shaped inductors are adhesively fixed through a magnetic conductive adhesive.

9. The transformer according to claim 5, wherein the at least two I-shaped inductors form a combined inductor, and one side, away from the electroplated pins, of the combined inductor is overlapped with the cover plate.

10. The transformer according to claim 5, wherein the I-shaped iron core is made of nickel-zinc material.

11. The transformer according to claim 5, wherein ends of the two coils are fixed to the two connecting parts by welding.

12. The transformer according to claim 5, wherein the electroplated pins comprise a first pin, a second pin, a third pin and a fourth pin, the first pin and the second pin are located on one of the two connecting parts, the third pin and the fourth pin are located on an other one of the two connecting parts, both ends of one of the two coils are respectively connected to the first pin and the second pin, and both ends of an other one of the two coils are respectively connected to the third pin and the fourth pin.

13. The transformer according to claim 10, wherein the at least two I-shaped inductors are arranged in sequence in a length direction of the winding part.

14. The transformer according to claim 11, wherein the at least two I-shaped inductors are arranged in sequence in a length direction of the winding part.

15. The transformer according to claim 12, wherein the at least two I-shaped inductors are arranged in sequence in a length direction of the winding part.

16. The transformer according to claim 10, wherein the at least two I-shaped inductors are arranged in a width direction of the winding part.

17. The transformer according to claim 11, wherein the at least two I-shaped inductors are arranged in a width direction of the winding part.

18. The transformer according to claim 12, wherein the at least two I-shaped inductors are arranged in a width direction of the winding part.

19. The transformer according to claim 10, wherein the cover plate and the at least two I-shaped inductors are adhesively fixed through a magnetic conductive adhesive.

20. The transformer according to claim 11, wherein the cover plate and the at least two I-shaped inductors are adhesively fixed through a magnetic conductive adhesive.
